(19) United States
(12) Patent Application Publication
(10) Pub. No.: US 2025/0368024 A1
(43) Pub. Date: Dec. 4, 2025

(54) APPARATUS FOR MOUNTING VEHICLE BATTERY

(71) Applicants: HYUNDAI MOTOR COMPANY, SEOUL (KR); KIA CORPORATION, SEOUL (KR)

(72) Inventors: Hyun Wook Park, Hwaseong-si (KR); Huen Sick Min, Hwaseong-si (KR)

(73) Assignees: HYUNDAI MOTOR COMPANY, SEOUL (KR); KIA CORPORATION, SEOUL (KR)

(21) Appl. No.: 18/968,209

(22) Filed: Dec. 4, 2024

(30) Foreign Application Priority Data
Jun. 4, 2024 (KR) 10-2024-0072767

(51) Int. Cl. B60K 1/04; H01M 50/242; H01M 50/249; H01M 50/262

(52) U.S. Cl. CPC B60K 1/04; H01M 50/242; H01M 50/249; H01M 50/262; B60K 2001/0438

(57) ABSTRACT

An apparatus for mounting a vehicle battery includes an underbody including a center floor and rear floor, and one or at least two cross members, longitudinal members, battery mounting brackets, etc. are mounted to a bottom portion of the underbody, allowing batteries in different sizes to be selectively mounted to the underbody and easily protecting the mounted batteries from a rear collision.

### CROSS REFERENCE TO RELATED APPLICATIONS

This application claims, under 35 U.S.C. § 119 (a), the benefit of and priority to Korean Patent Application No. 10-2024-0072767, filed on Jun. 4, 2024, the entire contents of which are incorporated herein by reference.

### TECHNICAL FIELD

The present disclosure relates to an apparatus for mounting a vehicle battery. More particularly, the present disclosure relates to an apparatus for mounting a vehicle battery, capable of mounting batteries in different sizes to a vehicle body and protecting the batteries from a rear collision.

### BACKGROUND

Generally, an electrified vehicle, such as a hybrid vehicle, hydrogen fuel cell vehicle, and electric vehicle, is equipped with a high-voltage battery (hereinafter abbreviated as a “battery”) to supply power to a motor for travelling and various electrical components.

The battery is mounted on a bottom portion of an underbody of a vehicle body, and particularly, a battery case intensively mounting therein a large number of battery cells, battery controllers, and electrical components for charging and discharging, etc. is mounted on the bottom portion of the underbody of the vehicle body.

Generally, only one size battery may be mounted in the limited space under the underbody of the vehicle body, and batteries of different sizes may not be mounted in the limited space under the underbody.

For example, because the underbody, including a center floor and rear floor, is designed to mount thereto only batteries in one size, only batteries of one size may be mounted in the limited space at the bottom of the underbody, and batteries in different sizes (e.g., batteries having different longitudinal lengths) may not all be selectively mounted.

Batteries of different sizes may be mounted to the bottom of the underbody when using a separate mounting member. However, due to the absence of a structure that protects the battery from a rear collision of the vehicle, the impact force resulted from the rear collision is directly transmitted to the battery, thereby damaging the battery.

The above information disclosed in this Background section is only for enhancement of understanding of the background of the present disclosure, and therefore it may contain information that does not form the prior art that is already known to a person of ordinary skill in the art.

### SUMMARY

The present disclosure has been made in an effort to solve the above-described problems associated with the prior art, and an object of the present disclosure is to provide an apparatus for mounting a vehicle battery, wherein the apparatus includes an underbody including a center floor and rear floor, and one or at least two cross members, longitudinal members, battery mounting brackets, etc. are mounted to a bottom portion of the underbody, allowing batteries in different sizes to be selectively mounted to the underbody and easily protecting the mounted batteries from a rear collision.

In one aspect, the present disclosure provides an apparatus for mounting a vehicle battery, wherein the apparatus includes an underbody having a structure in which a center floor, to which a battery selected from batteries in different sizes is mounted, and a rear floor, to which a rear sub-frame is mounted, are combined into one, a first cross member mounted on a front bottom surface of the rear floor, at least two longitudinal members connected between the center floor and the first cross member, and battery mounting brackets, each mounted at a predetermined position on a front-rear lengthwise section of the longitudinal member to thereby mount thereto a rear end portion of the battery.

In an embodiment, the first cross member may have opposite side end portions each connected to a corresponding one of rear side members each integrated with a corresponding one of opposite rear end side portions of the center floor.

In another embodiment, the center floor may further mount thereto, at a rear bottom surface thereof, a second cross member to which a front end portion of the longitudinal member is connected.

In still another embodiment, the second cross member may have opposite side end portions each connected to a corresponding one of rear side members each integrated with a corresponding one of opposite side portions of the rear floor.

In yet another embodiment, the battery may have a rear end portion provided with a mounting plate closely mounted to a lower end portion of the battery mounting bracket.

In still yet another embodiment, so as to mount a first battery, selected from the batteries in different sizes and having a longitudinal length greater than that of a second battery, the battery mounting bracket may be mounted at a rear predetermined position on the front-rear lengthwise section of the longitudinal member.

In a further embodiment, so as to mount the second battery, selected from the batteries in different sizes and having a longitudinal length smaller than that of the first battery, the battery mounting bracket may be mounted at a front predetermined position on the front-rear lengthwise section of the longitudinal member.

In another further embodiment, the battery mounting bracket may have a vertical length that is set to a length in which an upper surface portion of the battery is arranged lower than a bottom surface of a cross bar of the rear sub-frame by a set height.

In still another further embodiment, the crossbar of the rear sub-frame may be disposed rearward of the battery mounting bracket.

In yet another further embodiment, when the cross bar of the rear sub-frame is pushed forward and hits the battery mounting bracket in the event of a rear collision of a vehicle, the battery mounting bracket may absorb the impact energy resulting from the hit and be deformed.

In another aspect, the present disclosure provides an apparatus for mounting a vehicle battery, wherein the apparatus includes an underbody having a structure in which a center floor, to which a battery selected from batteries in different sizes is mounted, and a rear floor, to which a rear sub-frame is mounted, are combined into one, a first cross member mounted on a front bottom surface of the rear floor, a second cross member mounted on a rear bottom surface of the center floor, at least two longitudinal members connected between the first cross member and the second cross member, and battery mounting brackets each mounted at a predetermined position on a front-rear lengthwise section of the longitudinal member.

In an embodiment, the first cross member may have opposite side end portions each connected to a corresponding one of rear side members each integrated with a corresponding one of opposite rear end side portions of the center floor.

In another embodiment, the second cross member may have opposite side end portions each connected to a corresponding one of rear side members each integrated with a corresponding one of opposite side portions of the rear floor.

In still another embodiment, the battery may have a rear end portion provided with a mounting plate closely mounted to a lower end portion of the battery mounting bracket.

In yet another embodiment, so as to mount a first battery, selected from the batteries in different sizes and having a longitudinal length greater than that of a second battery, the battery mounting bracket may be mounted at a rear predetermined position on the front-rear lengthwise section of the longitudinal member.

In still yet another embodiment, so as to mount the second battery, selected from the batteries in different sizes and having a longitudinal length smaller than that of the first battery, the battery mounting bracket may be mounted at a front predetermined position on the front-rear lengthwise section of the longitudinal member.

In a further embodiment, the battery mounting bracket may have a vertical length that is set to a length in which an upper surface portion of the battery is arranged lower than a bottom surface of a cross bar of the rear sub-frame by a set height.

In another further embodiment, the crossbar of the rear sub-frame may be disposed rearward of the battery mounting bracket.

In still another further embodiment, when the cross bar of the rear sub-frame is pushed forward and hits the battery mounting bracket in the event of a rear collision of a vehicle, the battery mounting bracket may absorb the impact energy resulting from the hit and be deformed.

Other aspects and embodiments of the present disclosure are discussed infra.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

### BRIEF DESCRIPTION OF THE FIGURES

The above and other features of the present disclosure will now be described in detail with reference to certain exemplary embodiments thereof illustrated in the accompanying drawings which are given herein below by way of illustration only, and thus are not limitative of the present disclosure, and wherein:

FIG. 1 is a bottom view illustrating an apparatus for mounting a vehicle battery according to the present disclosure;

FIG. 2 is a perspective view illustrating a state in which a battery is mounted by an apparatus for mounting a vehicle battery according to the present disclosure;

FIG. 3 is a bottom view illustrating a state in which a battery is mounted by an apparatus for mounting a vehicle battery according to the present disclosure;

FIG. 4 is a side view illustrating a state in which a battery is mounted by an apparatus for mounting a vehicle battery according to the present disclosure;

FIG. 5 is a side view illustrating a motion in which a battery is protected by an apparatus for mounting a vehicle battery according to the present disclosure in the event of a rear collision;

FIG. 6 is a bottom view illustrating a state in which a battery mounting bracket of an apparatus for mounting a vehicle battery according to the present disclosure is mounted at a rear predetermined position on a longitudinal member;

FIG. 7 is a bottom view illustrating a state in which a battery mounting bracket of an apparatus for mounting a vehicle battery according to the present disclosure is mounted at a front predetermined position on a longitudinal member;

FIG. 8 is a bottom view illustrating a state in which a battery having a long longitudinal length is mounted by an apparatus for mounting a vehicle battery according to the present disclosure; and

FIG. 9 is a bottom view illustrating a state in which a battery having a short longitudinal length is mounted by an apparatus for mounting a vehicle battery according to the present disclosure.

It should be understood that the appended drawings are not necessarily to scale, presenting a somewhat simplified representation of various preferred features illustrative of the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

Descriptions of specific structures or functions presented in the embodiments of the present disclosure are merely exemplary for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

In this specification, the terms “first,” “second,” etc. may be used to describe various components, but the components are not limited to the terms. These terms are only used to distinguish one component from another. For example, a first component could be termed a second component, and similarly, a second component could be termed a first component, without departing from the scope of exemplary embodiments of the present disclosure.

Throughout the specification, like reference numerals indicate like components. The terminology used herein is for the purpose of illustrating embodiments and is not intended to limit the present disclosure. In this specification, the singular form includes plural forms unless specified otherwise. The terms “comprises” and/or “comprising” used in this specification mean that the cited component, step, operation, and/or element does not exclude the presence or addition of one or more of other components, steps, operations, and/or elements.

Hereinafter, embodiments of the present disclosure are described in detail with reference to the accompanying drawings.

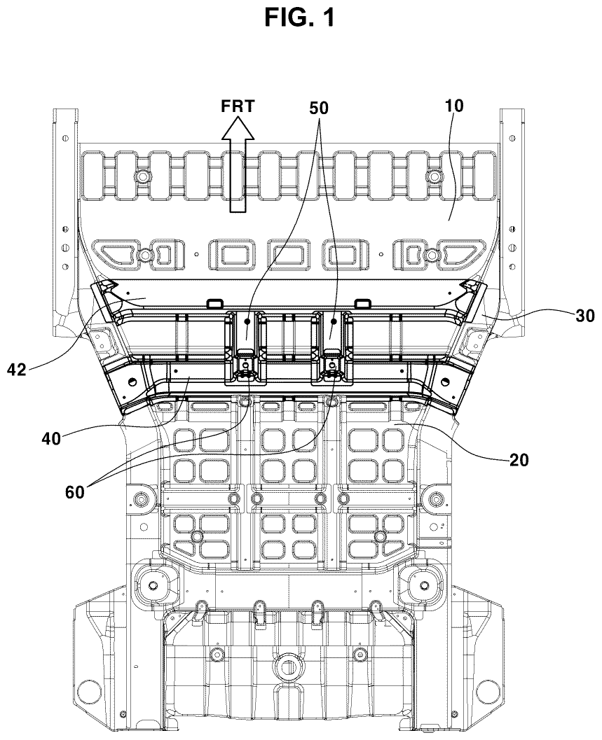

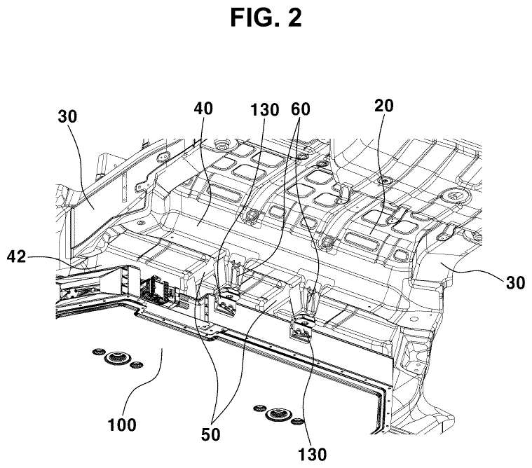

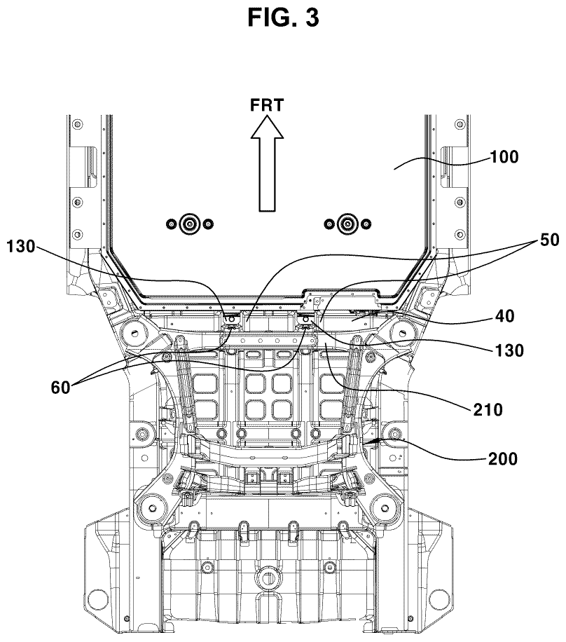

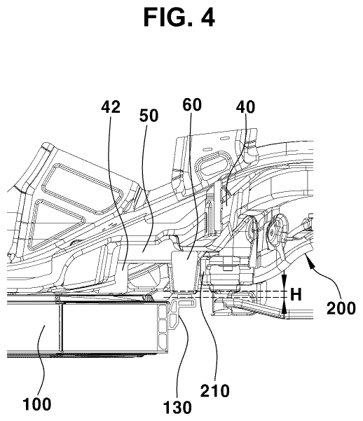

FIG. 1 illustrates an apparatus for mounting a vehicle battery according to the present disclosure, and FIG. 2, FIG. 3 and FIG. 4 each illustrate a state in which a battery is mounted by an apparatus for mounting a vehicle battery according to the present disclosure.

As illustrated in FIG. 1, an underbody of a vehicle body has a structure in which a center floor 10 and a rear floor 20 are constructed as a single piece.

The opposite rear end side portions of the center floor 10 and the opposite side portions of the rear floor 20 are provided with rear side members 30 each integrated with a corresponding one thereof. The rear side member 30 is a structure to which other vehicle components are assembled and serves to reinforce the rigidity of the opposite side end portions of the center floor 10 and of the rear floor 20.

At the bottom portion of the center floor 10, a battery 100 selected from batteries 100 having different sizes, i.e., one of the batteries 100 having different longitudinal lengths may be selectively mounted, and a rear sub-frame 200 to which a rear suspension is assembled is mounted on the bottom portion of the rear floor 20

A battery mounting apparatus according to an embodiment of the present disclosure may include a first cross member 40 mounted on the front bottom surface of the rear floor 20, at least two longitudinal members 50 connected between the center floor 10 and the first cross member 40, and battery mounting brackets 60 each mounted at a predetermined position on a front-rear lengthwise section of the longitudinal member 50.

The first cross member 40 is mounted on the front bottom surface of the rear floor 20 by welding, etc., and the opposite side end portions of the first cross member 40 are connected to the rear side members 30, each integrated with a corresponding one of the opposite rear end side portions of the center floor 10, by welding, etc.

Here, the longitudinal member 50 may be connected between the center floor 10 and the first cross member 40 by welding, etc.

More specifically, the front end portion of the longitudinal member 50 is welded to a predetermined position on the center floor 10, and the rear end portion of the longitudinal member 50 is welded to the bottom surface of the first cross member 40.

The first cross member 40 mounted in the above-described manner serves to reinforce the rigidity of the rear floor 20 and longitudinal member 50, and also serves as a reinforcement to prevent the longitudinal member 50 from being pushed forward due to the impact in a rear collision.

Particularly, so as to mount a battery 100 selected from the batteries 100 having different sizes, i.e., one of the batteries 100 having different longitudinal lengths, the battery mounting bracket 60 may be mounted at a predetermined position on the front-rear lengthwise section of the longitudinal member 50.

The battery mounting bracket 60 may have a vertically elongated hollow cuboid shape, so that the battery mounting bracket 60 may deform to cushion the striking force from the rear sub-frame 200 generated in a rear collision.

Here, the upper end surface of the battery mounting bracket 60 is welded to a predetermined position on the front-rear lengthwise section on the bottom surface of the longitudinal member 50, and thus the battery mounting bracket 60 may be arranged to face downward in a vertically upright state.

For example, a first battery 110 and a second battery 120 are different in longitudinal length, and the first battery 110 has a longitudinal length greater than that of the second battery 120. So as to mount the first battery 110, the battery mounting bracket 60 may be mounted at a rear predetermined position on the front-rear lengthwise section of the longitudinal member 50, as illustrated in FIG. 6 and FIG. 8.

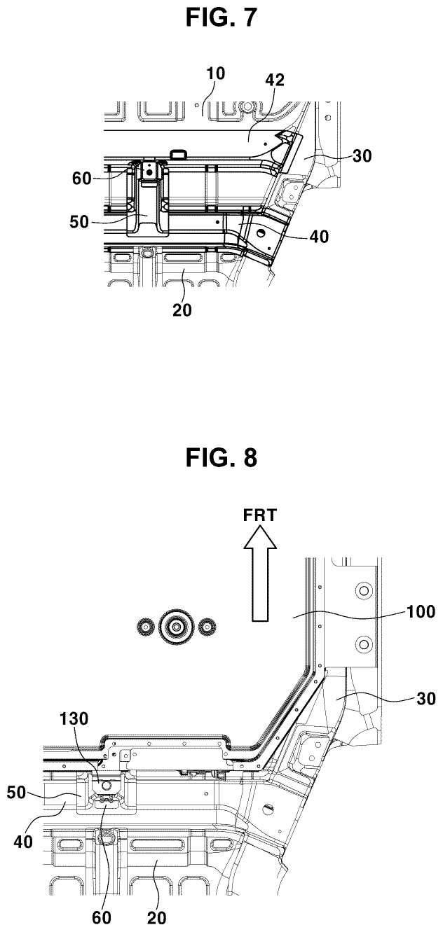

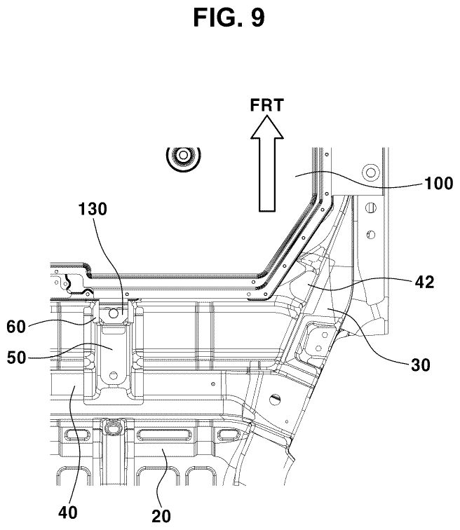

Alternatively, so as to mount the second battery 120 having a longitudinal length smaller than that of the first battery 110, the battery mounting bracket 60 may be mounted at a front predetermined position on the front-rear lengthwise section of the longitudinal member 50, as illustrated in FIG. 7 and FIG. 9.

To the lower end portion of the battery mounting bracket 60 mounted on the longitudinal member 50 as described above, the rear end portion of the battery 100 is connected.

To this end, a vertically bent mounting plate 130 is provided at the rear end portion of the battery 100, and the mounting plate 130 is attached to the lower end portion of the battery mounting bracket 60 by welding, etc. With the mounting plate 130, the rear end portion of the battery 100 is mounted on the lower end portion of the battery mounting bracket 60 that is mounted on the longitudinal member 50.

For example, as illustrated in FIG. 6 and FIG. 8, the rear end portion of the first battery 110 having a longitudinal length greater than that of the second battery 120 may be mounted on the lower end portion of the battery mounting bracket 60 mounted at the rear predetermined position on the front-rear lengthwise section of the longitudinal member 50 by welding, etc.

Alternatively, as illustrated in FIG. 7 and FIG. 9, the rear end portion of the second battery 120 having a longitudinal length smaller than that of the first battery 110 may be mounted on the lower end portion of the battery mounting bracket 60 mounted at the front predetermined position on the front-rear lengthwise section of the longitudinal member 50 by welding, etc.

Meanwhile, the vertical length (or vertical height) of the battery mounting bracket 60, i.e., the vertical length from the upper end to the lower end of the battery mounting bracket 60, extending downward and mounted on the longitudinal member 50, may be set to a length in which the upper surface portion of the battery 100 is arranged lower than the bottom surface of a cross bar 210, placed at the front of the rear sub-frame 200, by a set height (denoted as “H” in FIG. 4).

Accordingly, the cross bar 210 of the rear sub-frame 200 may be positioned right behind the battery mounting bracket 60 while maintaining a predetermined distance therebetween, and the battery mounting bracket 60 may be placed in a position where it may be hit by the cross bar 210 in the event of a rear collision.

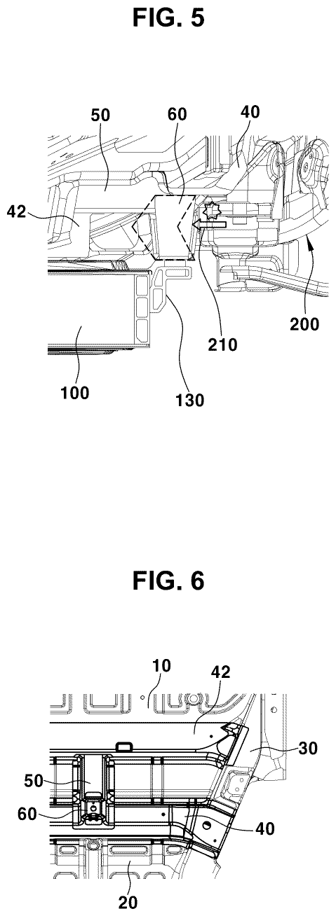

Therefore, when the cross bar 210 of the rear sub-frame 200 is pushed forward and hits the battery mounting bracket 60 in the event of a rear collision of the vehicle, the battery mounting bracket 60 absorbs the impact energy resulting from the hit and is deformed, as shown in the deformation trajectory of the battery mounting bracket indicated by the dotted line in FIG. 5, while simultaneously blocking the transmission of the impact energy to the battery 100, thereby protecting the battery 100 from damage from the rear collision.

To add up, because the battery mounting bracket 60 has a vertically elongated hollow cuboid shape, when the cross bar 210 of the rear sub-frame 200 hits the rear portion of the battery mounting bracket 60 in a rear collision, the battery mounting bracket 60 is deformed while absorbing the impact energy to thereby block the transmission of the impact energy to the battery 100, protecting the battery 100 from damage from the rear collision.

Moreover, because the rigidity of the rear floor 20 is reinforced by the first cross member 40 and the rigidity of the longitudinal member 50 is also reinforced due to the rear end portion of the longitudinal member 50 being connected to the first cross member 40, the longitudinal member 50 strongly prevents the rear sub-frame 200 from being pushed forward in the event of a rear collision, with only the battery mounting bracket 60 being deformed while absorbing the impact energy, to thereby block the impact energy from being transmitted to the battery 100.

Meanwhile, a battery mounting apparatus according to a different embodiment of the present disclosure may include a first cross member 40 mounted on the front bottom surface of a rear floor 20, a second cross member 42 mounted on the rear bottom surface of a center floor 10, at least two longitudinal members 50 connected between the first cross member 40 and the second cross member 42, and battery mounting brackets 60 each mounted at a predetermined position on a front-rear lengthwise section of the longitudinal member 50.

The second cross member 42 being mounted on the rear bottom surface of the center floor 10 may reinforce the rigidity of the center floor 10.

The opposite side end portions of the second cross member 42 are each connected to a corresponding one of rear side members 30 each integrated with a corresponding one of the opposite side portions of the rear floor 20, thereby reinforcing the mounting rigidity of the second cross member 42.

Specifically, by connecting the front end portion of the longitudinal member 50 to the second cross member 42, the mounting rigidity for the longitudinal member 50 may be reinforced.

More specifically, by welding the front end portion of the longitudinal member 50 to the second cross member 42 mounted on the rear bottom surface of the center floor 10, and by welding the rear end portion of the longitudinal member 50 to the bottom surface of the first cross member 40, the mounting rigidity for the longitudinal member 50 may be reinforced.

The second cross member 42 mounted in the above-described manner serves to reinforce the rigidity of the center floor 10 and longitudinal member 50 and also serves as a reinforcement, together with the first cross member 40, thereby preventing the longitudinal member 50 from being pushed forward due to the impact in a rear collision.

Therefore, because the rigidity of the rear floor 20 is reinforced by the first cross member 40 and the rigidity of the center floor 10 is reinforced by the second cross member 42, and because the rigidity of the longitudinal member 50 is also further reinforced by the front end portion and the rear end portion of the longitudinal member 50 being respectively connected to the second cross member 42 and to the first cross member 40, the longitudinal member 50 further strongly prevents the rear sub-frame 200 from being pushed forward in the event of a rear collision. Therefore, only the battery mounting bracket 60 is deformed while absorbing the impact energy and blocks the impact energy from being transmitted to the battery 100, thereby protecting the battery 100 from damage from the rear collision.

As is apparent from the above description, the present disclosure provides the following effects.

First, by mounting one or at least two cross members, longitudinal members, battery mounting brackets, etc. to the bottom of an underbody including a center floor and rear floor, batteries having different longitudinal lengths may be selectively mounted.

Second, when a cross bar of a rear sub-frame is pushed forward and hits the battery mounting bracket in the event of a rear collision of a vehicle, by allowing only the battery mounting bracket to deform while absorbing the impact energy resulting from the hit, the transmission of the impact energy to the battery may be blocked in the rear collision, and accordingly, the battery may be protected.

Third, by reinforcing the rigidity of the center floor and rear floor using one or at least two cross members and longitudinal members, only the battery mounting bracket is deformed in the event of a rear collision, and the impact energy is not transmitted to the center floor where the battery is mounted, preventing deformation of the center floor, thereby further strongly protecting the battery.

Although the present disclosure has been described in detail with reference to one embodiment, the scope of the present disclosure is not limited to the above-described embodiment, and various modifications and improvements by those skilled in the art based on the basic concept of the present disclosure as defined in the claims below will also be included in the scope of the present disclosure.

The invention claimed is:

1. An apparatus for mounting a vehicle battery, the apparatus comprising:
an underbody having a structure including a center floor and a rear floor, wherein a battery selected from a plurality of batteries of different sizes is mounted to the center floor, and wherein a rear sub-frame is mounted to the rear floor, wherein the center floor and the rear floor are formed as a single structure;
a first cross member mounted on a front bottom surface of the rear floor;
at least two longitudinal members connected between the center floor and the first cross member; and
a plurality of battery mounting brackets each of the plurality of battery mounting brackets being mounted at a predetermined position on a front-rear lengthwise section of each of the at least two longitudinal members to mount a rear end portion of the battery.

2. The apparatus according to claim 1, wherein the first cross member has a plurality of opposite side end portions each connected to a corresponding one of rear side members each integrated with a corresponding one of opposite rear end side portions of the center floor.

3. The apparatus according to claim 1, further comprising a second cross member mounted to a rear bottom surface of the center floor, wherein a front end portion of each of the at least two longitudinal members is connected to the second cross member.

4. The apparatus according to claim 3, wherein the second cross member has opposite side end portions each connected to a corresponding one of rear side members each integrated with a corresponding one of opposite side portions of the rear floor.

5. The apparatus according to claim 1, wherein the battery has a rear end portion provided with a mounting plate mounted to a lower end portion of the battery mounting bracket.

6. The apparatus according to claim 1, wherein, so as to mount a first battery, selected from the plurality of batteries of different sizes and having a longitudinal length greater than that of a second battery, each of the plurality of battery mounting brackets is mounted at a rear predetermined position on the front-rear lengthwise section of each of the at least two longitudinal members.

7. The apparatus according to claim 6, wherein, so as to mount the second battery, selected from the plurality of batteries of different sizes and having a longitudinal length smaller than that of the first battery, each of the plurality of battery mounting brackets is mounted at a front predetermined position on the front-rear lengthwise section of each of the at least two longitudinal members.

8. The apparatus according to claim 1, wherein each of the plurality of battery mounting brackets has a vertical length that is set to a length in which an upper surface portion of the battery is arranged lower than a bottom surface of a cross bar of the rear sub-frame by a set height.

9. The apparatus according to claim 8, wherein the cross bar of the rear sub-frame is disposed rearward of each of the plurality of battery mounting brackets.

10. The apparatus according to claim 1, wherein, when a cross bar of the rear sub-frame is pushed forward and hits each of the plurality of battery mounting brackets in an event of a rear collision of a vehicle, and each of the plurality of battery mounting brackets absorbs an impact energy resulting from the hit and is deformed.

11. An apparatus for mounting a vehicle battery, the apparatus comprising:
an underbody having a structure including a center floor and a rear floor, wherein a battery selected from a plurality of batteries of different sizes is mounted to the center floor, and wherein a rear sub-frame is mounted to the rear floor, wherein the center floor and the rear floor are formed as a single structure;
a first cross member mounted on a front bottom surface of the rear floor;
a second cross member mounted on a rear bottom surface of the center floor;
at least two longitudinal members connected between the first cross member and the second cross member; and
a plurality of battery mounting brackets each mounted at a predetermined position on a front-rear lengthwise section of each of the at least two longitudinal members.

12. The apparatus according to claim 11, wherein the first cross member has a plurality of opposite side end portions each connected to a corresponding one of rear side members each integrated with a corresponding one of opposite rear end side portions of the center floor.

13. The apparatus according to claim 11, wherein the second cross member has a plurality of opposite side end portions each connected to a corresponding one of rear side members each integrated with a corresponding one of opposite side portions of the rear floor.

14. The apparatus according to claim 11, wherein the battery has a rear end portion provided with a mounting plate mounted to a lower end portion of each of the plurality of battery mounting brackets.

15. The apparatus according to claim 11, wherein, so as to mount a first battery, selected from the plurality of batteries of different sizes and having a longitudinal length greater than that of a second battery, each of the plurality of battery mounting brackets is mounted at a rear predetermined position on the front-rear lengthwise section of each of the at least two longitudinal members.

16. The apparatus according to claim 15, wherein, so as to mount the second battery, selected from the plurality of batteries of different sizes and having a longitudinal length smaller than that of the first battery, each of the plurality of battery mounting brackets is mounted at a front predetermined position on the front-rear lengthwise section of each of the at least two longitudinal members.

17. The apparatus according to claim 11, wherein each of the plurality of battery mounting brackets has a vertical length that is set to a length in which an upper surface portion of the battery is arranged lower than a bottom surface of a cross bar of the rear sub-frame by a set height.

18. The apparatus according to claim 17, wherein the cross bar of the rear sub-frame is disposed rearward of each of the plurality of battery mounting brackets.

19. The apparatus according to claim 11, wherein, when a cross bar of the rear sub-frame is pushed forward and hits each of the plurality of battery mounting brackets in an event of a rear collision of a vehicle, and each of the plurality of battery mounting brackets absorbs an impact energy resulting from the hit and is deformed.
